(19) United States
(12) Patent Application Publication
(10) Pub. No.: US 2004/0218261 A1
(43) Pub. Date: Nov. 4, 2004

(54) Conduction and correction of a light beam

(76) Inventor: Jukka Tuunanen, Helsinki (FI)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/486,824

(22) PCT Filed: Aug. 20, 2002
(86) PCT No.: PCT/FI02/00680

(30) Foreign Application Priority Data
Aug. 20, 2001 (FI) 20011672

(51) Int. Cl. G02B 17/00; G02B 21/00; G02B 23/00

(52) U.S. Cl. 359/364; 359/366

(57) ABSTRACT

An apparatus for the conduction of light. The apparatus includes two concave refracting elements, such as spherical mirrors or concave gratings, such that a connecting line segment between centers of the elements forms with a main axis of a first element an angle of incidence in excess of zero, and with a main axis of a second element an angle of incidence equal in size but in a plane perpendicular to the plane defined by the connecting line segment and the main axis of the first element. Thus, astigmatism error can be corrected. The apparatus is applicable in optical analyzers for conduction of measuring light to or from a sample.

### FIELD OF TECHNOLOGY

The invention relates to curved optical refraction equipment, and deals with conduction of light by means of spherical mirrors or concave gratings. The invention can be applied for example in optical analyzers, such as analyzers in clinical chemistry, which are used for measuring optical radiation emanating from a sample placed in a container.

### TECHNOLOGICAL BACKGROUND

In optical analyzers, the conduction of measuring light is generally performed by using lens systems. For example, WO 97/11354 discloses a fluorometer, wherein a detector is supplied with measuring light from a defined area in a sample well by means of a plane mirror and lenses. The light to be processed in such an apparatus has a wavelength which is typically within the range of 320-800 nm. The effect of imaging errors in lenses, such as dispersion, can be quite extensively minimized in lens optics. Generally, however, correction can only be optimally made on a specific wavelength. When a more extensive wavelength range is required, the application of lens optics becomes highly inconvenient. In lens optics, dispersion can be corrected by combining different types of glass. If a very broad wavelength range (e.g. 200-1000 nm) is desired, the virtually only applicable lens material is synthetic silica. However, even it has a dispersion which constitutes a problem, and colour correction is very difficult to perform.

### GENERAL DESCRIPTION OF THE INVENTION

An apparatus as set forth in claim 1 has now been invented for the conduction of light. A few implementations of the invention are disclosed in other claims.

When a concave mirror is used to provide an image of a point existing outside an optical axis, the rays propagating in various planes of a light beam establish imaging points at different distances. Extreme cases are constituted by rays traveling in a plane defined by a point and the main axis (horizontal plane) and in a plane perpendicular thereto (vertical plane). The nearest will be the focus of a ray traveling in the horizontal plane and the farthest the focus of a ray traveling in the vertical plane. In vertical plane, the curvature of a mirror has projected to a wider extent, which results in an imaging point being established further away. This is referred to as astigmatism.

One application of concave mirrors is the conduction of light with gratings. A grating comprises a plurality of closely situated slots, in which lights with different wave lengths are diffracted at different angles. There are transmitting gratings and refracting gratings. The latter are more common in practice. Usually the refracting grating is plane. Such a grating is relatively simple to prepare geometrically and the operation is near ideal. In this case additional optics is needed to create parallel light to be conducted to the grating and to collect the desired light from the grating. The additional optics usually comprises two spherical mirrors, such as in the well-known Czerny-Turner grating optics. The first mirror is used to make the beam parallel before the grating, and the second mirror focuses the out put beam. Another well-known arrangement with a plane grating is the Ebet-Fastie optics. In this arrangement a conical beam is conducted to a concave mirror outside the axis to collimate the beam and to reflect it to a grating. From the grating light is conducted on the opposite area of the mirror. Astigmatism is a significant problem also in these cases.

To avoid the use of additional optics with gratings, concave gratings are used. A conical light beam is conducted to such a grating, and the grating forms converging light cones at different angles in accordance with wave length. The grating thus acts in a way as a concave mirror. Also in this case astigmatism is a special problem. This is emphasized as usually the angle between the input axis and output axis is very large, typically 20-60°, such as 30-50°, when rotation is used for wave length selction. A concave grating forms from a pointlike object a linelike image. E.g. in many kinds of optical analysers it is necessary to create monochromatic light and to conduct it as a small dot to a desired place, such as a sample in a small vessel. The same applies also when monochromatic light shall be conducted e.g. from a small sample. If the optics produces a linelike image, only a part of it can thus be used, which causes undesirable damping. In order to avoid astigmatism, the surface of the grating can be made nonspherical. Such a grating is very difficult to prepare. Another possibility is to use an uneven groove density, which is easier to prepare. However, also such a correction works satisfactorily only at certain wave length areas, and the other areas remain rather uncorrected.

In many systems, two gratings in series are used in order to decrease diffuse light. Diffuse light is caused by incompleteness of the slot surface, so that besides the desired wave length, also other wave lengths are transmitted. The level of such diffuse light may be e.g. in the range of 1:100-1:1000. When two concave gratings are used in series, the astigmatism is further increased. In many cases the astigmatism thus becomes quite untolerable, e.g. in fluorometry when excitating small sample well.

The inventive arrangement comprises two concave elements, such as concave mirrors or gratings. The connecting line segment between the centres of the elements forms with the main axis of the first element an angle of incidence other than zero, and with the main axis of the second element an equal angle of incidence, but in a plane which is perpendicular to a plane defined by the connecting line segment and the main axis of the first element. Hence, this enables the elimination of astigmatism created in the visualization of a point existing outside the optical axis of a system.

In practical optical arrangements, the angle of incidence for mirrors is typically 5-20°, such as 10-15°.

According to the invention, it is possible to provide an accurate image of an object external to the main axis of refracting element. The object can be further way than the focal plane. Thus, the ratio of imaging can be for example 0.5-2:1, typically about 1:1. The object may also lie in the focal plane of a first element, whereby the first element produces an image at infinity, from which an image is produced on the focal plane by a second element.

A benefit of the invention is its ability to guide or conduct light onto or from a precisely defined small area, respectively. This enables measuring for example very small and very closely placed samples. The diameter of an image to be produced or an object to be visualized can be for example in the order of 0.5-2 mm, such as about 1 mm.

Another benefit of the invention is its ability to function equally well at all wavelengths of light. Thus, one and the same apparatus can be used for processing lights of even highly unequal wavelengths in an equally flawless manner. For example, the wavelength range needed in conventional analyzers can be 200-1000 nm. Efficiency is high as a result of utilizing mirror surfaces over a section as large as possible, and hence a solid angle as large as possible. A large solid angle suppresses respectively less an optical signal, and thus enhances measuring response.

The invention is particularly applicable in optical analyzers, wherein light is conducted to or from a sample. Such analyzers include for example photometers, fluorometers, and luminometers. For example, analyses dealing with clinical chemistry, biochemistry, and molecular biology may involve the use of sample or specimen plates provided with wells having diameters of only 2 mm. Considering tolerances (e.g. positioning), the well in this case has a measuring range whose diameter available for an optical analysis is approximately 1 mm. In addition, the well has an entrance in the form of a narrow tunnel-like passage. According to the invention, this can be managed and, furthermore, the entire solid angle afforded by a well can be deployed. Problems caused by crosstalk from well to well can also be avoided by accurate focusing of light.

When, according to the invention, the imaging procedure is performed twice, the imaging direction can be constructed in a sensible manner, such that the image will be on the opposite side of the optics with respect to the sample.

The light to be focused on a sample is usually conducted or guided through a monochromator. The monochromator can be especially a grating. The grating module produces a diverging light pencil, having an exit surface the size of a slit in the grating module. The exit light pencil of the grating module is imaged on a sample according to the invention. The imaging ratio can be for example 1:1, provided that the exit slit is of a suitable size. The imaging ratio can be varied for further adjusting the size of a slit to be as closely consistent as possible with the size of a sample. There can be several gratings, especially two, connected in series, for providing a particularly narrow wavelength band (see e.g. WO 00/63680). The light emanating from a sample is also conducted to a detector, usually through a monochromator. The monochromator for outbound light can be similar to that for inbound light, in which the light travels in an opposite direction. The optics coupled with a grating monochromator must be able to accept quite a wide angle for the light pencil, since it is necessary to cover quite a large section of the grating for a high wavelength resolution and good measuring response. This is well feasible in accordance with the invention.

In an arrangement comprising conical gratings, astigmatism can be corrected in corresponding way as with mirrors, i.e. tilting the plane of the second grating 90°. This can be accomplished with two gratings or with one grating using different areas of the grating. A small imaging error is of spherical mirrors is borne, which sets the minimum spot size of the system. With a single grating, stray light level may minimum spot size of the system. With a single grating, stray light level may be too high. This may be significantly decreased by using two gratings in series. Both gratings can be uncorrected or (partially) corrected against astigmatism or other optical errors.

Between the gratings there is usually a small opening opening to let the selected light beam to penetrate to the second grating. This minimizes straylight transmission. When there are two linelike focuses between the gratings, it is possible to use two slits, which further increases straylight elimination.

A photometer is used for measuring the absorption of light passing through a sample. The invention can be applied for conducting light from a light source to a sample or from a sample to a detector. Regarding photometry, it is particularly important to control the passage of a light beam through a sample container in order to achieve a high measuring response in terms of concentration.

In a fluorometer, a sample is exposed to excitation light, the emission light produced thereby in the sample being delivered to a detector. The invention can be applied for the conduction of either, most preferably both. This can also be effected by one and the same arrangement, particularly by conducting excitation radiation to a sample within a beam of emission radiation emanating therefrom. It can be implemented for example by providing the arrangement in a suitable position with a dichroic mirror (see WO 97/11354). The mirror can be located especially upstream of the first spherical mirror. Although both spherical mirrors are in operation twice, there will be no crosstalk as excitation and emission photons travel in different directions.

Excitation and emission beams can also be separated from each other by means of a plane mirror smaller than the beam, the excitation beam and the emission beam being within each other. It is especially useful to employ a plane mirror smaller than the emission beam, whereby emission rays pass by the mirror.

In fluorometry, particular benefits include preclusion of crosstalk and improved stability of measuring results. Measuring can also be performed from very small wells, even less than 2 mm in diameter. The use of one and the same set of mirrors for the conduction of both excitation light and emission light leads to savings in component costs. The adjustability of imaging optics is also simple as the optical axes are coinciding. The total absence of lenses in the arrangement serves to eliminate background fluorescence problems usually associated therewith.

A luminometer is used for supplying a detector with luminescent light originated in a sample, and this can be implemented by means of an arrangement of the invention.

Samples can be placed in the wells of a sample plate consisting of a plurality of wells, said sample plate being maneuvered for bringing each well in its turn to a measuring site. The plate can be mounted on a frame which is maneuvered within a light-tight space present in the lower section of the apparatus, for example as described in WO 97/11352. The plate can be for example a conventional microtitration plate provided with 12×8 wells with a 9 mm graduation. However, the plate can also be designed to have considerably smaller wells, for example with 384 or up to 1536 wells to an equivalent area. According to the invention, the crosstalk between wells is avoided within the range of normal positioning tolerances for the plates. However, photometer application does not in practice enable measuring from wells as small as those used in fluorometer or luminometer application.

In an optical analyzer, the inventive measuring optics is most preferably set in a housing provided with a suitable arrangement for conducting light from the measuring optics to a sample or from a sample to the measuring optics. This arrangement may include a plane window for conducting light therethrough. The window is preferably made of silica. When the window is positioned in a suitably inclined position relative to a light path, some of the light is reflected at a corresponding angle and the reflected portion can be readily used as reference light. The window has a reflection which is for example 5-20%, such as about 8%. The angle of incidence can be for example 10-40°, such as about 25°. The window can be included in a housing wall and, if necessary, removable for special measurements.

The measuring optics is preferably such that it produces a point- or dot-like image on a sample.

The housing may be further provided with an output aperture for conducting (emission) light out of measuring optics to reading optics. In the best case, the measuring optics is such that it produces an image, preferably a point-like image, in the output aperture. The output aperture lies in a plane which is preferably perpendicular to the light path.

The housing may be additionally provided with an input aperture for conducting (excitation) light from light source optics (excitation optics) to measuring optics. The light source optics is preferably such that it produces a point-like image in the input aperture. The input aperture lies in a plane which is preferably perpendicular to the light path.

When light propagates between the mirrors in the form of a parallel beam, a properly positioned delimiter can be used for correcting error caused in a measurement by varying distances of an object. A proper distance is about half of the radius of curvature of a first mirror used for imaging an object.

### DESCRIPTION OF THE DRAWINGS

The accompanying drawings constitute a part in a detailed description of the invention.

FIG. 1 shows development of an image in a spherical mirror from an extra-axial point in a horizontal plane.

FIG. 2 shows an arrangement of the invention for conducting light by means of spherical mirrors.

FIG. 3 shows another arrangement of the invention for conducting light by means of spherical mirrors.

FIG. 4 shows vignetting in an arrangement consistent with FIG. 3.

FIGS. 5a and 5b show an arrangement of the invention in a fluorometer.

FIG. 6 shows development of excitation light that can be used in the fluorometer of FIGS. 5a and 5b.

FIG. 7 shows the arrangement of FIG. 5b in a fluorometer fitted with one arrangement for processing emission light.

FIG. 8 shows an arrangement of the invention in a photometer.

FIG. 9 shows an arrangement of the invention in a luminometer.

FIG. 10 shows an arrangement of the invention with one spherical mirror and a plane mirror.

FIG. 11 shows development of astigmatism with a concave grating.

FIG. 12 shows an arrangement of the invention with one concave grating and a plane mirror.

FIG. 13 shows an arrangement of the invention with two spherical mirrors and two plane gratings.

### DETAILED DESCRIPTION FOR SOME EMBODIMENTS OF THE INVENTION

When an object to be imaged with a spherical mirror lies outside an optical axis, the result will be an astigmatic flaw as a point-like object is visualized as a line segment. The reason for this is that light beams emanating from an object in a variety of planes come to contact with a mirror at different angles, and thus are also reflected at different angles. The extreme cases are created by beams traveling in a plane defined by the point and the main axis (horizontal plane) and in a plane perpendicular thereto (vertical plane). The nearest will be the focus of a beam traveling in the horizontal plane and the farthest will be the focus of a beam traveling in the vertical plane.

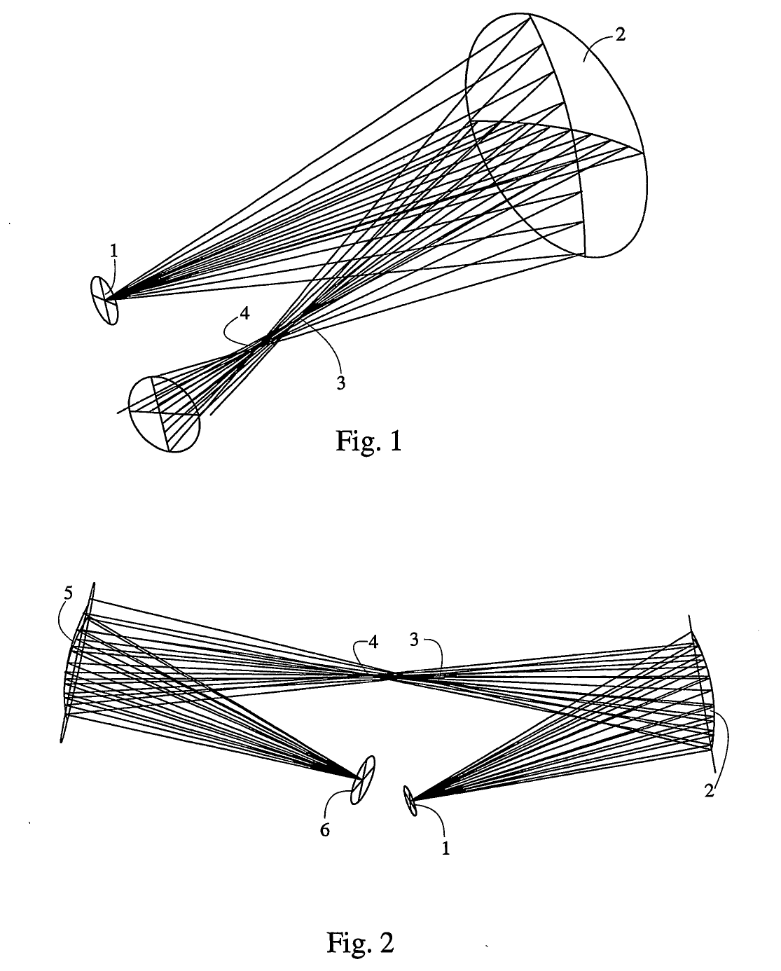

FIG. 1 visualizes the development of astigmatism. An imaging object 1 is focused in the rotational plane (horizontal plane) of a concave spherical mirror 2 at a point 3. In vertical plane, the image shall develop further away at a focus 4, and the focus 3 will be visualized as a vertical line segment. Respectively, the focus 4 is provided with a horizontal line segment by beams traveling in the horizontal plane. The mirror-produced image will be out-of-focus even at the best focal point, i.e. halfway between the points 3 and 4. The distance between focal points becomes longer as the rotational angle of a mirror increases.

Astigmatic flaw can be corrected by cutting the mirror to an aspheric shape. However, such cutting is a highly exacting procedure as the required surface is not even rotationally symmetrical. And this procedure is only capable of correcting astigmatism developing from a specific point. Cutting may also impair the optical properties of a mirror surface.

The arrangement of FIG. 2 comprises two equal-radius (R) concave spherical mirrors: a first mirror 2 and a second mirror 5. An object 1 is located at the centre of curvature of the first mirror, i.e. at a distance R. The inter-mirror distance is 2R, and an image 3, 4 developed by the first mirror constitutes an object for the second mirror. The second mirror develops an image 6 at a distance R from the second mirror.

The first mirror is rotated in a horizontal plane (i.e. the rotational plane is a horizontal plane). The second mirror is rotated to the same extent in a plane perpendicular to this plane.

As shown in FIG. 1, the first mirror 2 develops two successive focal points 3 and 4. The point 3 comprises an image produced by the horizontal portion, and the point 4 has an image produced by the vertical portion. The point 6 develops a perfectly point-like image, which is corrected regarding astigmatism.

Halfway between the provisional focuses 3 and 4 can be arranged a circular intermediate aperture for limiting propagation of scattered or diffused light between the mirrors. The intermediate aperture can also be positioned accurately at 3 or 4, whereby the aperture can take the form of a slit consistent with a linear image of the object. Some sort of combination may even be considered, including a solution which has a separate linear aperture provided for each provisional focal line.

When the mirrors 2 and 5 are located at a distance of their very own radii of curvature from an object and an image, and also from the provisional focal points 3 and 4, the imaging process does not develop spherical aberration.

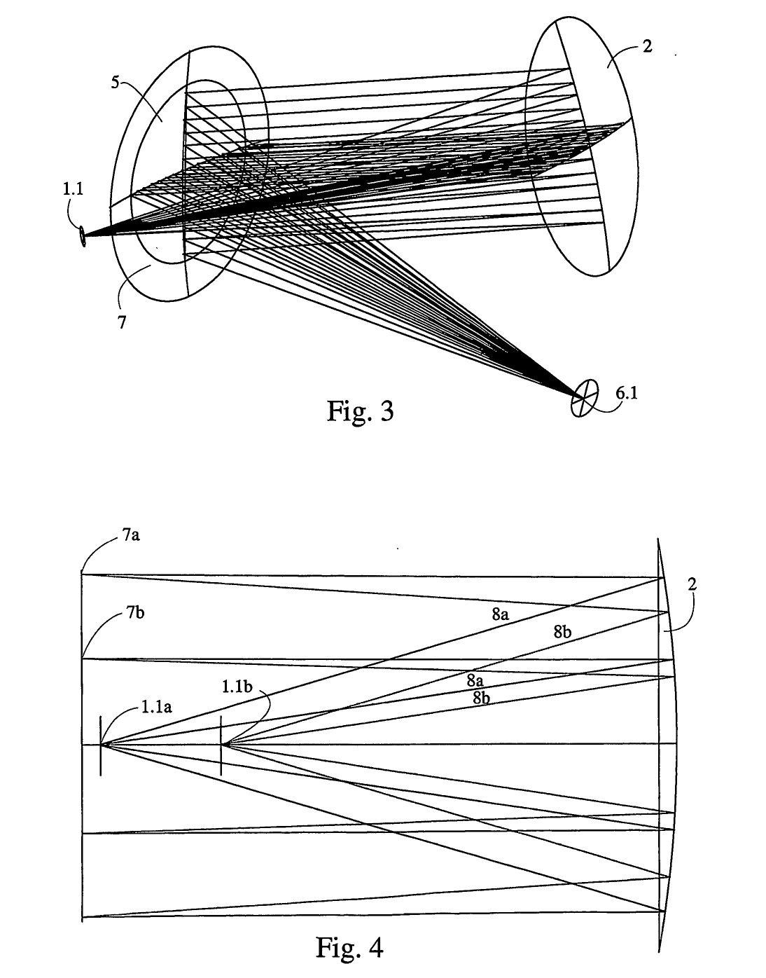

The arrangement of FIG. 3 comprises a first mirror 2 and a second mirror 5, rotated relative to each other in a manner consistent with FIG. 4. The first mirror is rotated in a horizontal plane (defines the horizontal plane), and the second mirror is rotated to the same extent in a vertical plane. An object 1.1 is placed at the focal point of the first mirror, the beams reflecting from the mirror being substantially parallel and the image developing at infinity. The path of a light beam emanating from the first mirror is blocked by the second mirror. Each mirror develops astigmatism in imaging, but the astigmatism is eliminated and a point- or dot-like image 6.1 is produced.

A particular advantage gained by the arrangement of FIG. 3 is the location of an object and an image on either side of mirror optics, whereby the positioning of optics is easy. In the solution of FIG. 2, an object and an image are close to each other, which may easily result in problems regarding space. The solution to such problems may require, for example, a deflection of the beam by means of a plane mirror.

In the case of FIG. 3, the image is not as precisely dot-like as in the arrangement of FIG. 2 because of a flaw caused by spherical aberration. Still, even in this case, the image can be made quite substantially smaller than what is achieved with a single mirror. At least in the subsequently described applications this imaging flaw is not significant.

The optical power transmission of a visualized object is proportional to the square of a distance. This may cause problems for example in fluorometry, as variations in the distance of an object result in a respective change in the solid angle at which emission is detected. This may constitute a major source of error, for example in the use of sample well plates, if liquid volumes vary from one recess to the next. The volume variation can be even intentional, for example in dilution sets. Error may also result from normal tolerances and curvature fluctuations of the plates. If the optics has a measuring range which is for example 100 mm, 1 mm change in the range or distance results in a measuring error of about 2%.

In the arrangement of FIG. 3, the influence of distance variation is refuted by fitting a shading rim or circle 7 around the second mirror 5. This shading rim defines a solid angle for the system as a result of vignetting. As a result of selecting a proper distance between the mirrors, the vignetting effect increases with an object closer and decreases with an object further away. This enables refuting the influence of distance variations for an object, and for example the measurement of emission radiation is always performed at a constant solid angle. The distance between mirrors is most preferably a half of the radius of curvature of the mirrors, i.e. R/2.

Vignetting is visualized further in FIG. 4. The mirror 2 has a radius of 200 mm. An object 1.1a is set at a distance of 97 mm, and an object 1.1b at a distance of 77 mm.

At a distance of 100 mm from the mirror are set aperture rings 7a and 7b. As can be appreciated, the change in object position (1.1a→1.1b) does not alter the size of a solid angle opening from the object, since straight lines 8A and 8B (with the larger aperture ring 7a) are parallel. The solid angle remains independent of a change in the position of an object also at various aperture ring diameters (a pair of straight lines 9A, 9B with the smaller ring 7b).

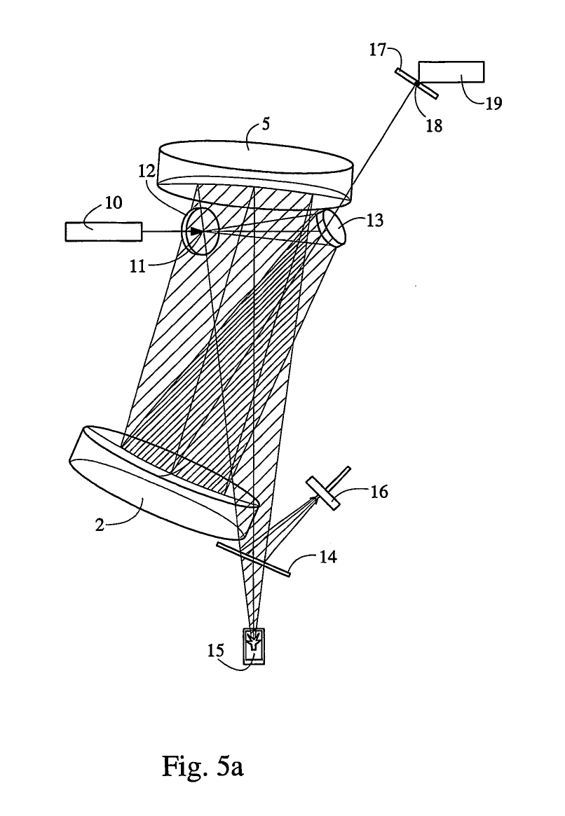

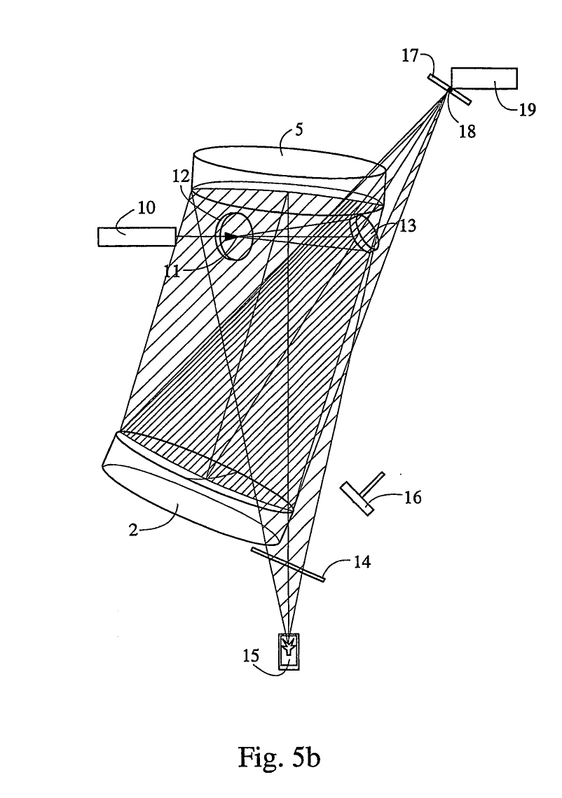

FIGS. 5a and 5B illustrate an optics arrangement of the invention as applied to a fluorometer. For improved visualization, the figures illustrate separately the passages of excitation and emission light.

Excitation light is delivered from excitation optics 10 to measuring optics, which is fitted in a housing in the shape of a rectangular polyhedron. The housing is provided in its top section with a lateral input aperture 11, which is supplied with excitation light delivered orthogonally from the excitation optics to constitute a point-like object. The light beam arrives obliquely relative to the housing side wall, which is why the wall is formed with a bracket 12, having a receiving surface perpendicular to the light beam and provided with the input aperture.

From the input aperture 11 the light beam is reflected with a small-size plane mirror 13 to a first concave mirror 2 in such a way that the latter issues a parallel light pencil to a second, similar concave mirror 5, having a plane of inclination which is at a 90° angle relative to the plane of inclination of the first mirror. In this arrangement, astigmatism is refuted and the second concave mirror develops a dot-like image through a glass window 14 in a measuring well 15 down below, which contains a sample to be measured.

The glass window 14 is slightly askew with respect to the light path. A portion of excitation light reflects from the window surface to a reference detector 16. The reference detector lies in an optics-established image plane the same way as the measuring well. The reference detector is used for monitoring the intensity fluctuation at a light source, which is taken into account when calculating fluorescence. Since the light pencil in in the process of converging towards the well 15, the light pencil colliding with the reference detector also converges in a respective manner. If the window has a reflection of about 8%, the total signal loss will be less than 20%. This does not substantially impair responsivity of the apparatus. In order to avoid potential background fluorescence, the window can be made as thin as possible.

The window functions also as a shield for measuring optics, whereby the sample well is housed in an enclosed space, from which moisture or other fumes cannot find a way inside the optics. The window material is most preferably silica. The window must be set at a sufficient distance above the measuring well 15, such that spatters from possible metering devices cannot reach the window surface.

The emission light created in the measuring well 15 progresses by way of the second mirror 5 to the first mirror 2, and thence towards a plane mirror 13. A portion of the emission light passes by the mirror outside the same for a dot-like, astigmatically corrected image straight onto an aperture 18 a housing surface projection 17, from which it is conducted to emission reading optics 19.

Thus, a function of the plane mirror 13 is to separate excitation light from emission light. For a maximum efficiency the division ratio is most preferably about 50%50%.

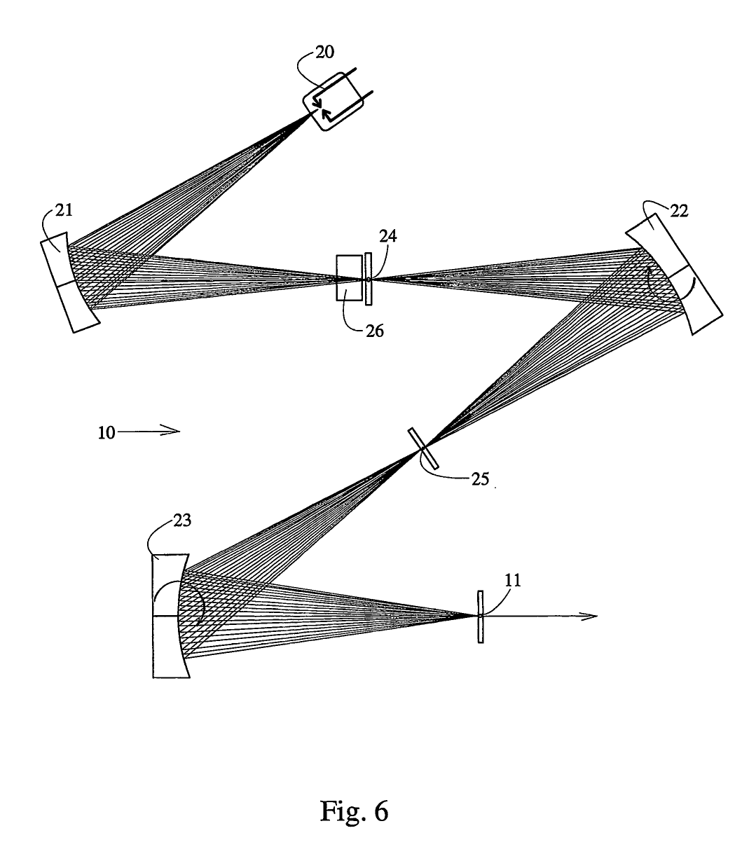

FIG. 6 illustrates excitation optics 10 for conducting light to measuring optics. From a lamp 20 (e.g. a flashing xenon lamp) light is delivered by way of a concave mirror 21 and two concave interference gratings 22 and 23 to the input aperture 11 of measuring optics. Between the mirror and the first grating the image point has an intermediate slit 24 and between the gratings an intermediate slit 25 for eliminating diffused light. Upstream of the first intermediate slit is further provided an order reading filter 26 for the grating.

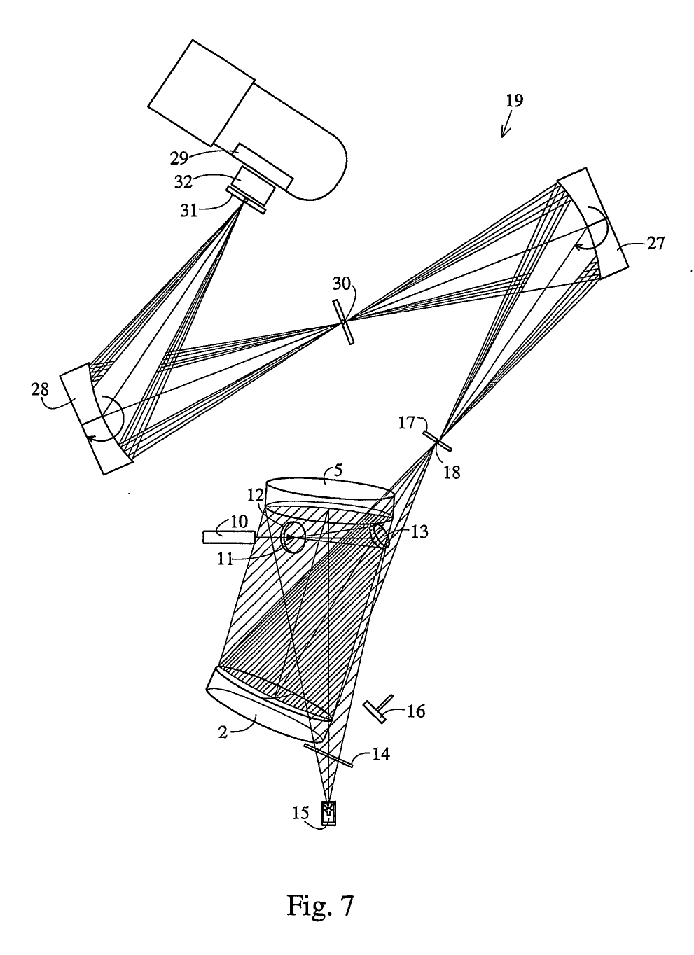

FIG. 7 illustrates emission reading optics 19 integrated with the measuring optics of FIG. 5b. From an output aperture 18 of the measuring optics, light is guided by way of two concave interference gratings 27 and 28 to a detector 29 (a photomultiplier tube). Between the gratings is an intermediate slit 30. The detector is preceded by a slit 31 and a filter 32.

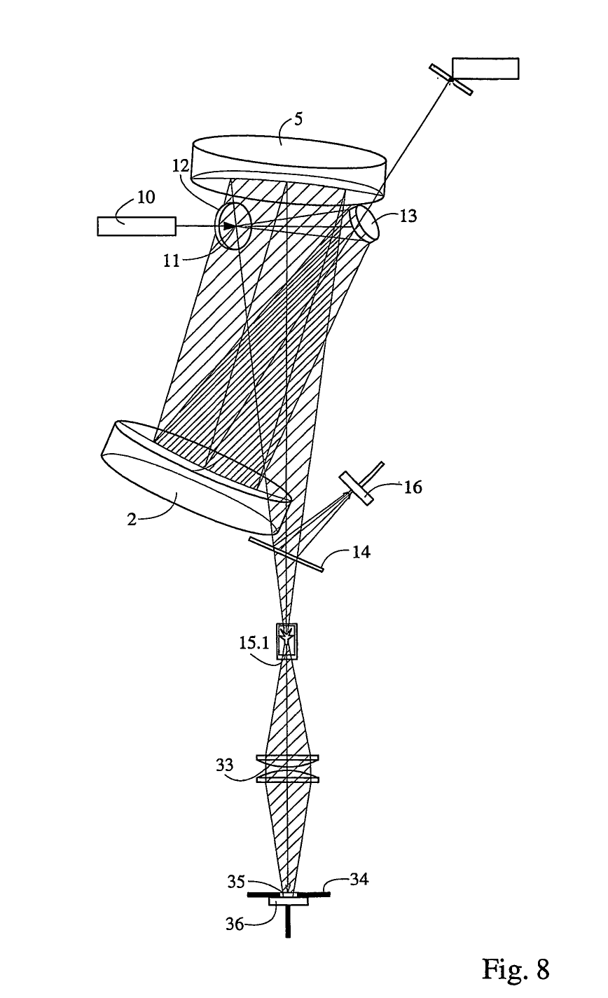

FIG. 8 shows the application of the optics of FIGS. 5a and 5b for photometric measuring.

A measuring well 15.1 has a light transmissive bottom and (excitation) light is passed through the well, followed by measuring the volume of radiation absorbed in a sample. The measurement of absorbance requires precise control of the light beam in a well, and precise control of the excitation plane. The excitation plane is measured with a reference detector 16, which is able to see the beam of rays which is exactly the same as the one delivered into a well to be measured. The light beam is carried through the measuring well. The light beam diffusing after the well is conducted to a detector 36 through optics 33 comprising two opposing plano-convex lenses and through a circular aperture 35 in a delimiter plate 34. If the distance from lens optics is sufficiently short and the detector area is sufficient, the dispersion of a lens material (preferably silica) does not have an impact on the measuring result, as long as the light beam is able to accommodate itself on the detector surface in all circumstances.

The collection of a light beam downstream of the well can also be performed, as in measuring optics, by means of two mirrors set at an angle for a totally dispersion-free operation.

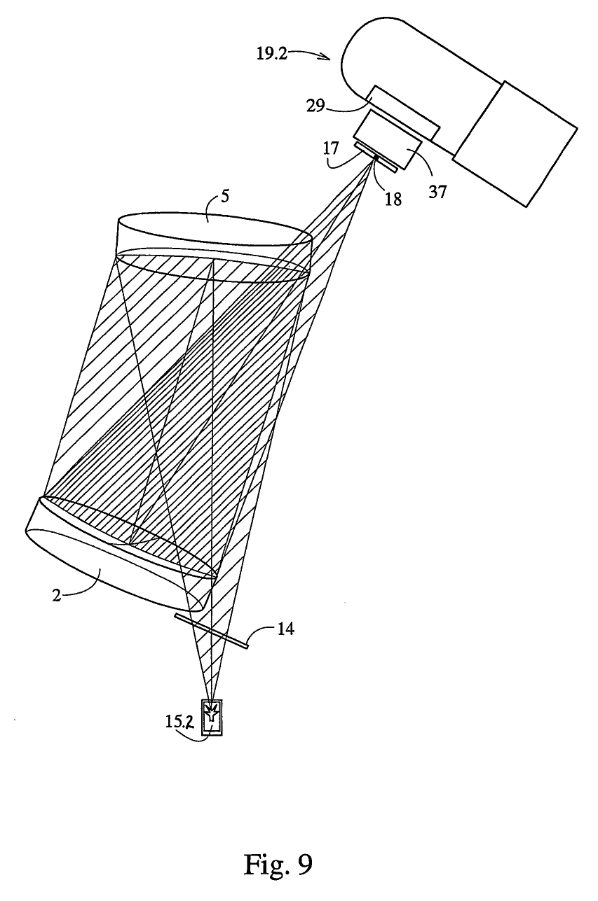

FIG. 9 shows the application of the optics of FIGS. 5a and 5b for luminometric measuring.

In luminometry, light is produced in a measuring well 15.2 without excitation.

Luminometric measuring enables the use of a filter 37 upstream of a detector 29 (a photomultiplier tube) included in reading optics 19.2. In addition to the filter, it may be necessary to provide a light path block for the measurement of a bottom level. A suitable plug or shutter can be integrated with a filter mechanism (one filter=plug).

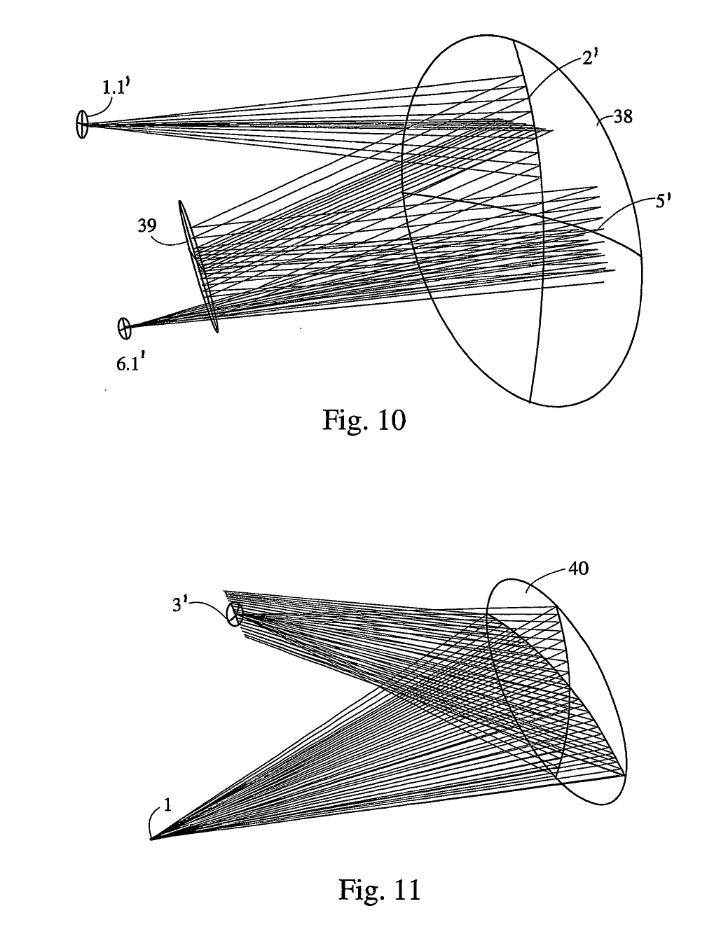

FIG. 10 shows an arrangement with a spherical mirror 38 and a plane mirror 39.

Light is conducted form an object 1.1′ to a first mirror area 2′ of the spherical mirror outside its centre, from the first area as a beam of parallel light to the plane mirror, from the plane mirror to a second area 5′, and from the second area to form an image 6.1′. The plane mirror is tilted so that the beam hits back on the mirror 90° right or left from the first area. Thereby astigmatism is corrected. Here only one spherical mirror is needed, although it should be larger. The plane mirror is centered to the optical axis of the spherical mirror and the hitting areas are at the same distance of the centre of the spherical mirror.

FIG. 11 shows the formation of astigmatism with a concave grating 40. From a pointlike object 1, a line segment is formede at focus plane 3′.

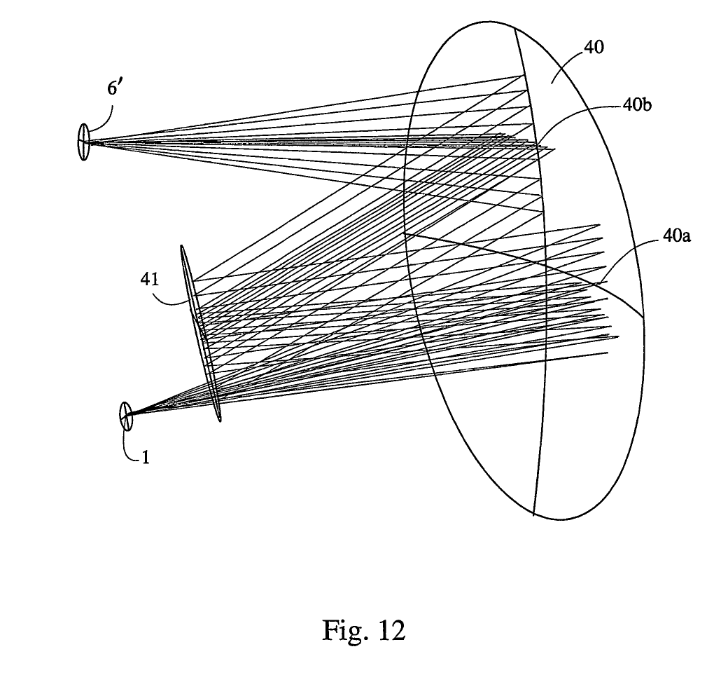

FIG. 12 shows an arrangement with a concave grating 40 and a plane mirror 41.

Light is conducted form an object 1 to a first grating area 40a of the grating outside its centre, from the first area the light of desired wave length is conducted as a planelike bundle of parallel beams to the plane mirror, and from the plane mirror to a second area 40b. The second area is located at the same distance from the centre as the first and the plane mirror is located so that the areas are at 90° angle relative to each other when seen e.g. form front. Astigmatism is hereby corrected, and a pointlike image 6′ is formed.

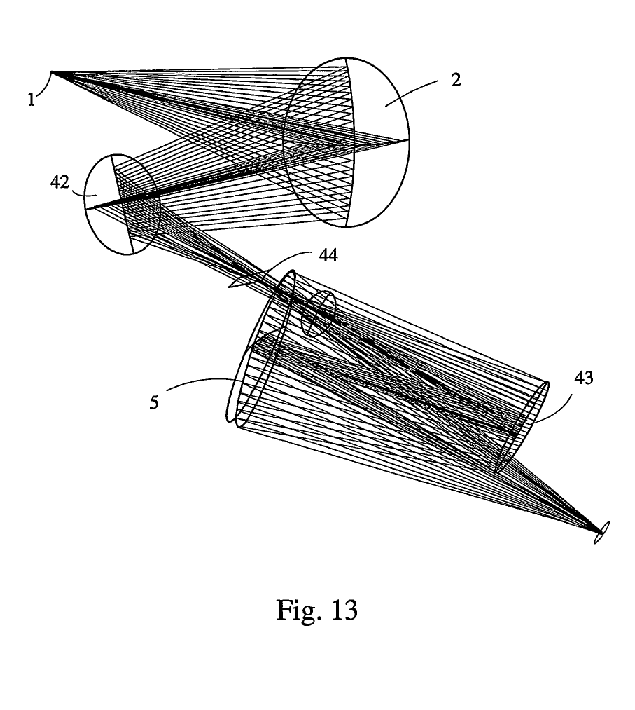

FIG. 13 shows an arrangement in which light is conducted from point 1 to a first spherical mirror 2, to a first plane grating 42, to a second plane grating 43, to a second spherical mirror 5 to form a pointlike image 6 of highly monochromatic light. The mirrors are place at 900 angle as explained above in order to eliminate astigmatism. A slit 44 is placed at the intermediate focus.

1-18. (Cancelled).

19. An apparatus in an optical analyzer, provided with measuring optics for conduction of measuring light to a sample or from a sample, said apparatus comprising:
a first concave refracting element and a second concave refracting element configured such that light can be passed between the first concave refracting element and the second concave refracting element,
wherein a connecting line segment between centers of the first and second concave refraction elements forms with a main axis of a first element an angle of incidence in excess of zero, and with a main axis of a second element an angle of incidence equal in size but in a plane perpendicular to a plane defined by the connecting line segment and the main axis of the first element.

20. An apparatus according to claim 19 for developing an image from an object.

21. An apparatus according to claim 20, wherein the object is located at a center of curvature of the first element, or the object is located at a focal point of the first element.

22. An apparatus according to claim 20 for developing an image from a point-like object.

23. An apparatus according to claim 21 for developing an image from an object present in a focal plane of the first element.

24. An apparatus according to claim 19, wherein at least one of the first and second refractive elements includes a spherical mirror or a concave grating.

25. An apparatus according to claim 23, wherein at least one of the first and second refractive elements includes a spherical mirror and an angle of incidence is 5-20°, preferably 10-15°, or the at least one of the first and second refractive elements includes a concave grating and the angle of incidence is 20-60°, preferably 30-50°.

26. An apparatus according to claim 19, wherein light is passed through limiters between the first and second concave refracting elements.

27. An apparatus according to claim 19, wherein at least one of the first and second refracting elements includes a shading rim.

28. An apparatus according to claim 19 utilized in a photometer, fluorometer, or luminometer.

29. An optical analyzer, comprising:
measuring optics with an apparatus for conduction of measuring light to a sample or from a sample, said measuring optics comprising:
a first concave refracting element and a second concave refracting element configured such that light can be passed between the first concave refracting element and the second concave refracting element,
wherein a connecting line segment between centers of the first and second concave refracting elements forms with a main axis of a first element an angle of incidence in excess of zero, and with a main axis of a second element an angle of incidence equal in size but in a plane perpendicular to a plane defined by the connecting line segment and the main axis of the first element.

30. An analyzer according to claim 29, wherein the measuring optics is set in a housing provided with at least one of an input aperture for guiding light to the measuring optics and with an output aperture for guiding light away from the measuring optics.

31. An analyzer according to claim 30, further comprising light source optics configured to guide measuring light to form a dot-like object in the input aperture, or wherein the measuring optics develops a dot-like image in the output aperture.

32. An analyzer according to claim 29, wherein the measuring optics is set in a housing provided with a window to guide light from the measuring optics to a sample or from a sample to the measuring optics, said window being preferably set askew with respect to a light path passing therethrough.

33. An analyzer according to claim 29, wherein said measuring optics is provided with a plane mirror for conduction of light.

34. An analyzer according to claim 29, wherein an image ratio of the optical system formed by the mirrors is 0.5-2:1, preferably about 1:1.

35. An analyzer according to claim 29 for conducting measuring light to and from the sample, wherein the measurement light to the sample is excitation light and the measurement light from the sample is emission light.

36. An analyzer according to claim 35, wherein the measurement and excitation lights are within each other.
